(19) United States
(12) Patent Application Publication
(10) Pub. No.: US 2026/0246717 A1
(43) Pub. Date: Aug. 20, 2026

(54) MODEL MANAGEMENT METHOD AND WIRELESS COMMUNICATION DEVICE

(71) Applicant: SHENZHEN TCL NEW TECHNOLOGY CO., LTD., Shenzhen, Guangdong (CN)

(72) Inventor: Miao QU, Shenzhen, Guangdong (CN)

(73) Assignee: SHENZHEN TCL NEW TECHNOLOGY CO., LTD., Shenzhen, Guangdong (CN)

(21) Appl. No.: 19/493,085

(22) PCT Filed: May 11, 2023
(86) PCT No.: PCT/CN2023/093704

§ 371 Date: Dec. 12, 2025

(51) Int. Cl. H04L 41/16; H04W 24/10

(52) U.S. Cl. CPC H04L 41/16; H04W 24/10

(57) ABSTRACT

A model management method for artificial intelligence (AI)/machine learning (ML) is provided. A wireless communication device executes the method to perform AI/ML model monitoring for one or more AI/ML models and/or performing lifecycle management (LCM) according to AI/ML model monitoring configuration.

### TECHNICAL FIELD

The present disclosure relates to the field of communication systems, and more particularly, to a model management method and a wireless communication device.

### BACKGROUND ART

Artificial intelligence (AI) and machine learning (ML) are two related fields of computer science that aim to create systems that can perform tasks that normally require human intelligence and learning. ML can be used to solve various problems in domains such as natural language processing, computer vision, robotics, and bioinformatics. Recently, AI/ML has been increasingly applied to telecommunication networks.

The general framework for the study of AI/ML over air inference has been proposed. This framework illustrates how data collection can facilitate some AI actions, such as model training and model inference.

### Technical Problem

The wireless communication system performance can be enhanced by AI/ML assisted services. However, it can be expected that system performance may also deteriorate due AI/ML model failures. Therefore, the criteria for enabling managing operations for AI/ML models should be made clear.

AI/ML-assisted services can improve the performance of wireless communication systems. However, the AI/ML model may also fail and degrade the system performance. Therefore, it is important to establish the criteria for managing the AI/ML model throughout its lifecycle.

Hence, an AI/ML model monitoring method for enhancing the current wireless communication system is desired.

### Technical Solution

An object of the present disclosure is to propose a wireless communication device, such as a user equipment (UE) or a base station, and a model management method based on machine learning.

In a first aspect, an embodiment of the invention provides a model management method for machine learning (ML), executable in at least one wireless communication device, comprising: performing AI/ML model monitoring for one or more AI/ML models and/or lifecycle management (LCM) according to AI/ML model monitoring configuration.

In a second aspect, an embodiment of the invention provides a wireless communication device comprising a processor configured to call and run a computer program stored in a memory, to cause a device in which the processor is installed to execute the disclosed method.

In a third aspect, an embodiment of the invention provides a wireless communication system or artificial intelligence (AI)/machine learning (ML), comprising:
a base station; and
a user equipment (UE);
wherein the base station configures AI/ML model monitoring configuration for one or more AI/ML models;
at least one of the base station or the UE performs model monitoring for the one or more AI/ML models and/or lifecycle management (LCM) for the one or more AI/ML models according to AI/ML model monitoring configuration; and
at least one of the base station or the UE makes a decision associated with at least one AI/ML model in the one or more AI/ML models.

The disclosed method may be implemented in a chip. The chip may include a processor, configured to call and run a computer program stored in a memory, to cause a device in which the chip is installed to execute the disclosed method.

The disclosed method may be programmed as computer-executable instructions stored in non-transitory computer-readable medium. The non-transitory computer-readable medium, when loaded to a computer, directs a processor of the computer to execute the disclosed method.

The non-transitory computer-readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as a computer program product, which causes a computer to execute the disclosed method.

The disclosed method may be programmed as a computer program, which causes a computer to execute the disclosed method.

### Advantageous Effects

This disclosure proposes a method of monitoring the AIML model between the user equipment (UE) and the network (gNB, LMF, etc.), which can reduce the signaling overhead and enhance the system performance. The method involves sending and receiving model monitoring requests and responses between the UE and the network and updating the AI/ML model accordingly.

Embodiments of the disclosure describe a comprehensive method for monitoring the performance and quality of AI/ML models throughout their life cycle management (LCM), which is an aspect that the current research does not address.

The disclosure enhances AI/ML models for wireless communication systems.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure. A person having ordinary skill in this field can obtain other figures according to these figures without paying the premise.

FIG. 1 illustrates a schematic view showing an AI/ML system in the disclosed AI/ML framework.

FIG. 2 illustrates a schematic view showing a wireless communication system comprising a user equipment (UE), a base station, and a network entity.

FIG. 3 illustrates a schematic view showing a system with an AI/ML functional framework for executing a model management method using ML models.

FIG. 4 illustrates a schematic view showing an embodiment of the disclosed method.

FIG. 5 illustrates a schematic view showing a first configuration of the system.

FIG. 6 illustrates a schematic view showing a second configuration of the system.

FIG. 7 illustrates a schematic view showing a third configuration of the system.

FIG. 8 illustrates a schematic view showing a fourth configuration of the system.

FIG. 9 illustrates a schematic view showing a first example of signaling in the disclosed method.

FIG. 10 illustrates a schematic view showing a second example of signaling in the disclosed method.

FIG. 11 illustrates a schematic view showing a third example of signaling in the disclosed method.

FIG. 12 illustrates a schematic view showing a fourth example of signaling in the disclosed method.

FIG. 13 illustrates a schematic view showing an example for triggering different LCM actions.

FIG. 14 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Abbreviations used in the description are listed in the following:

TABLE 1

| | |
|---|---|
| 3G | Third generation |
| 3GPP | Third Generation Partnership Project |
| 5GC | 5G Core Network |
| ACK | Acknowledgment |
| AI | Artificial intelligence (AI) |
| AMF | Access and mobility management function |
| API | application programming interface |
| BLER | Block Error Rate (BLER) |
| BS | Base station |
| CE | Control element |
| CN | Core network |
| CU | Centralized Unit |
| CNN | Convolutional neural network (CNN) |
| CPU | CPU (Central Processing Unit) |
| CSI | Channel state information (CSI) |
| DBN | Deep belief network (DBN) |
| DCI | Downlink control information (DCI) |
| DMRS | Demodulation Reference Signal (DM-RS) |
| DU | Distributed Unit |
| eMMB | enhance Mobile Broadband |
| FAR | False acceptance rate (FAR) |
| FDD | Frequency-division duplex (FDD) |
| FLOPS | Floating-point operations per second |
| gNB | Generation Node B |
| GPU | GPU (graphics processing unit) |
| ID | Identifier/Identification |
| IMEI | International Mobile Equipment Identity (IMEI) |
| IPC | Instructions Per Clock |
| KNN | K-nearest neighbor (KNN) |
| LCM | Life cycle management |
| LMF | Location management function |
| LPP | LTE Positioning Protocol |
| LTE | Long Term Evolution |
| MAC | Media Access Control |
| MAO | Management and orchestrator |
| MIB | Master Information Block (MIB) |
| MIMO | Multi-input multi-output (MIMO) |
| ML | machine learning (ML) |
| MSER | Minimum symbol error rate (MSER) |
| NR | New Radio |
| NW | Network |
| OS | Operating system |
| PDSCH | Physical downlink shared channel (PDSCH) |
| PDCCH | Physical downlink control channel (PDCCH) |
| PSSCH | Physical sidelink shared channel (PSSCH) |
| PUSCH | Physical uplink shared channel (PUSCH) |
| PLMN | Public land mobile network (PLMN) |
| PTRS | Phase tracking reference signal (PTRS) |
| RAN | Radio Access Network |
| RRC | Radio resource control (RRC) |
| RS | |
| SDK | Software development kit (SDK) |
| SIB | System Information Block (SIB) |
| SINR | Signal-to-interference plus noise ratio (SINR) |
| SRS | Sounding Reference Signal (SRS) |
| SVM | Support vector machine (SVM) |
| TA | Tracking area |
| TRS | Tracking reference signal (TRS) |
| UE | User Equipment |
| UPF | User Plane Function |
| UL | Uplink |
| UUID | Universally unique identifier (UUID) |
| RNN | Recurrent Neural Network (RNN) |
| RSRP | Reference signal received power (RSRP) |
| RSRQ | Reference signal received quality (RSRQ) |

Embodiments of the disclosure are related to artificial intelligence (AI) and machine learning (ML) for wireless communication system, such as LTE or new radio (NR) air interface, and address problems of AI/ML model ID.

For simplicity, in the description an AI/ML model, AI model, ML model, and model are interchangeably used, also, AI/ML model monitoring and model monitoring are interchangeably used. In the description, Life cycle management (LCM) may comprise model selection, activation, deactivation, switching, fallback, model training, model monitoring, model registration, model deployment, model transfer retraining/fine-tuning at least for one-sided models and two-sided models.

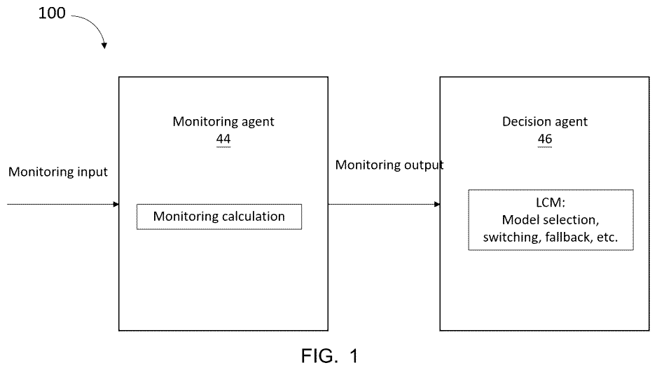

With reference to FIG. 1, a system architecture for AI/ML framework in a telecommunication network is provided. In the system architecture, a system 100 comprises a monitoring agent 44 and a decision agent 46. The monitoring agent 44 receives monitoring input, performs calculations on the monitoring input, and generates result of the calculation as monitoring output. The monitoring agent 44 provides the monitoring output to the decision agent 46. The decision agent 46 makes a decision of a lifecycle management (LCM) based on the monitoring output.

AI/ML model monitoring is the process of tracking and evaluating the performance of one or more AI/ML models and/or LOM over time. The monitoring agent 44 collects data as monitoring input, which may be at one least of inference accuracy, system throughput, spectrum efficiency, NACK ratio, ACK ratio, SINR, RSRP, RSRQ, beam failure, link failure, positioning, intra-cell interference, inter-cell interference, BLER, MSER and FAR, performance loss, performance gain, channel information (e.g., real-time channel matrix, long-term channel matrix, CSI, eigen-vector, etc.), input/output data distribution, and/or applicable condition(s), as well as applies various metrics and calculations on the monitoring input to assess the model's accuracy, reliability, fairness, and robustness. Based on the monitoring output, The decision agent 46 can make informed decisions to maintain the AIML model, and/or take corrective actions of LCM, (e.g., selecting, switching, activating, deactivating, or falling back to different AI/ML models or non-AI modules) to address any issues or anomalies detected by the monitoring agent 44.

AI/ML models can be installed and executed in one or more UE(s) and NW (e.g., base station, LMF, etc.) In the description, one or more AI/ML models may be installed and executed in UE 10 or/and installed and executed in a NW 20, wherein the AI/ML model(s) is used for different feature and/or functions considering one-side model, and/or two side model.

The system 100 enables operators to train custom AI/ML models and integrate third-party AI/ML models under their control. This system architecture allows network-based AI/ML services to support a wider range of partners and deliver services that meet market needs. The disclosed system and methods can improve service quality and increase market competitiveness.

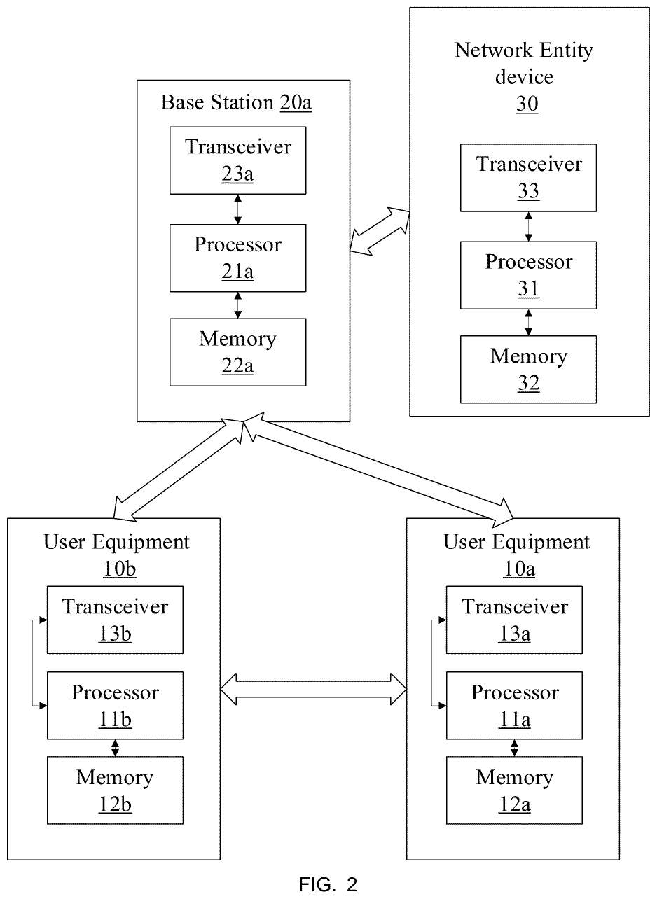

With reference to FIG. 2, a telecommunication system including a UE 10a, a UE 10b, a base station (BS) 20a, and a network entity device 30 executes the disclosed method according to an embodiment of the present disclosure. FIG. 2 is shown for illustrative not limiting, and the system may comprise more UEs, BSs, and CN entities. Connections between devices and device components are shown as lines and arrows in the FIGs.

The base station 20a can operate as a gNB for 5G NR networks, an eNB for LTE networks, or a base station for future mobile network systems beyond 5G. A gNB is a 5G radio network node that connects to the core network via the NG interface. An eNB is a 4G radio network node that connects to the evolved packet core via the S1 interface. A base station for beyond 5G may be a smart virtual eNB (SVeNB) that can perform functions of EPS elements and reduce end-to-end delay.

The UE 10a may include a processor 11a, a memory 12a, and a transceiver 13a. The UE 10b may include a processor 11b, a memory 12b, and a transceiver 13b. The base station 20a may include a processor 21a, a memory 22a, and a transceiver 23a. The network entity device 30 may include a processor 31, a memory 32, and a transceiver 33. Each of the processors 11a, 11b, 21a, and 31 may be configured to implement proposed functions, procedures and/or methods described in the description. Layers of radio interface protocol may be implemented in the processors 11a. 11b, 21a, and 31. Each of the memory 12a, 12b, 22a, and 32 operatively stores a variety of programs and information to operate a connected processor. Each of the transceivers 13a, 13b, 23a, and 33 is operatively coupled with a connected processor, and transmits and/or receives radio signals or wireline signals. The UE 10a may be in communication with the UE 10b through a sidelink. The base station 20a may be an eNB, a gNB, or one of other types of radio nodes, and may configure radio resources for the UE 10a and UE 10b.

Each of the processors 11a, 11b, 21a, and 31 may include an application-specific integrated circuit (ASICs), other chipsets, logic circuits and/or data processing devices. Each of the memory 12a, 12b, 22a, and 32 may include read-only memory (ROM), a random-access memory (RAM), a flash memory, a memory card, a storage medium and/or other storage devices. Each of the transceivers 13a, 13b, 23a, and 33 may include baseband circuitry and radio frequency (RF) circuitry to process radio frequency signals. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art.

The network entity device 30 may be a node in a CN. CN may include LTE CN or 5G core (5GC) which includes user plane function (UPF), session management function (SMF), access and mobility management function (AMF), unified data management (UDM), policy control function (PCF), control plane (CP)/user plane (UP) separation (CUPS), authentication server (AUSF), network slice selection function (NSSF), and the network exposure function (NEF). LMF, AF

An example of the UE in the description may include one of the UE 10a or UE 10b. An example of the base station in the description may include the base station 20a. The NW 20 may be a gNB or a base station of any other types of base stations, such as an eNB or a base station for beyond 5G. Uplink (UL) transmission of a control signal or data may be a transmission operation from a UE to a base station. Downlink (DL) transmission of a control signal or data may be a transmission operation from a base station to a UE. A DL control signal may comprise downlink control information (DCI) or a radio resource control (RRC) signal, from a base station to a UE.

### AI/ML Functional Framework:

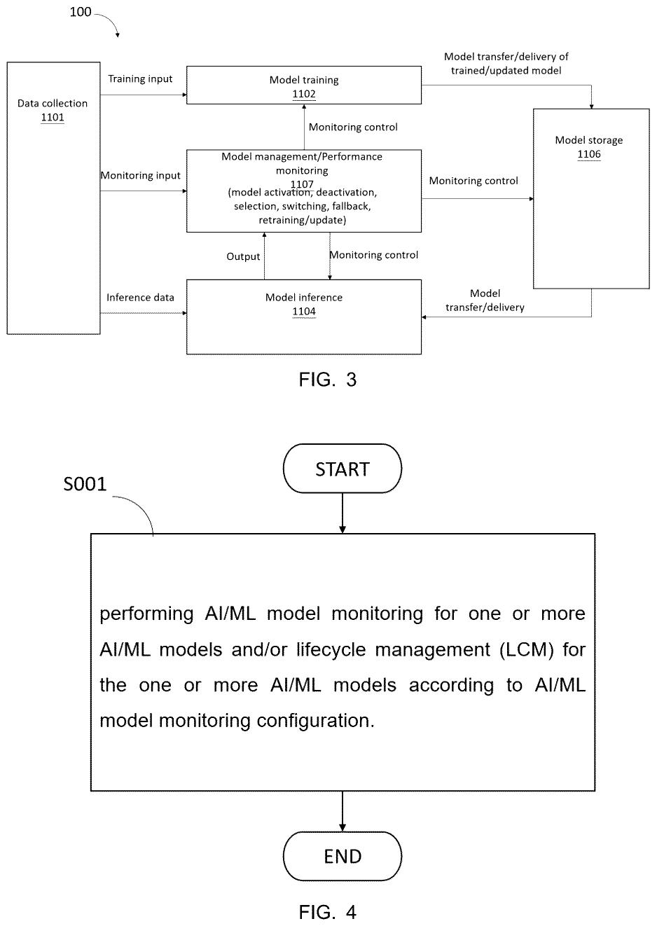

A general functional framework of AIML is used to show the logical relationship among LCM actions. A possible AI/ML functional framework is shown in FIG. 3.

With reference to FIG. 3, the general AI/ML functional framework should consist of the following functional blocks.
Data Collection: A data collection unit 1101 is functional block that is used for collection of the measurements/data for various actions of life cycle management (LCM), such as model training unit 1102, model inference unit 1104, and model management/performance monitoring unit 1107. The data collection unit 1101 works for one-sided model, and/or two-sided model.
Model Training: A model training unit 1102 is functional block that is used for performing model training. The model training unit 1102 may perform model training, validation, test, and finally produces a trained model.
Model management/performance monitoring: A model management/performance monitoring unit 1107 is a functional block that is used for performing model management including at least one of the followings: model monitoring, selection, activating, deactivating, switching, and fallback. Moreover, the function block may provide control signaling to model inference unit 1104, or model training 1102, or model storage 1106.
Model Inference: A model inference unit 1104 is a functional block that is used for performing model inference. This functional block produces inference output of AI/ML models. The model inference unit 1104 uses the data from data collection as input and uses the trained AI/ML model given by model training unit 1102 to provide a set of inference output. The output of model monitoring can trigger a set of AI/ML model actions and also can be an input for model monitoring function.
Model Storage: A model storage unit 1106 is a functional block is used to store the trained/updated/retrained/fine-tuned models.

FIG. 4 shows an embodiment of the disclosed method. At least one wireless communication device may be a network entity and executes a model management method based on machine learning. In an embodiment, the at least one wireless communication device may comprise a user equipment (UE). In another embodiment, the at least one wireless communication device may comprise NW. In still another embodiment, the at least one wireless communication device may comprise a combination of UEs and NW.

The at least one wireless communication device performs AI/ML model monitoring for one or more AI/ML models and/or lifecycle management (LCM) for the one or more AI/ML models according to AI/ML model monitoring configuration (S001). The model monitoring may be performed by a user equipment (UE) or NWV.

Before the monitoring, the method may comprise transmitting or receiving AI/ML model monitoring activation and deactivation signaling. The AI/ML model monitoring activation and deactivation signaling comprises one or more of: AI/ML model monitoring threshold, AI/ML model monitoring object, activating time, and deactivating time.

In an embodiment, AI/ML model activation for one or more AI/ML models is signaled by the AI/ML model monitoring configuration or an activation message or is controlled according to a predefined rule.

The activation message comprises AI/ML model Activate/Deactivate information for the AI/ML model activation, and the AI/ML model Activate/Deactivate information comprises one or more of:
an AI/ML model ID,
activate/deactivate information,
activate timing.
deactivate timing, and
a timing window.

The AI/ML model monitoring configuration may comprise one or more of:
AI/ML monitoring configuration ID,
AI/ML model ID.
AI/ML model monitoring object,
AI/ML model monitoring metrics,
AI/ML model monitoring report configuration,
AI/ML model monitoring report configuration ID.
AI/ML model monitoring report type,
AI/ML model monitoring threshold.
AI/ML model monitoring reference signal,
AI/ML model monitoring time window,
time to trigger,
model monitoring reporting amount,
monitoring reporting interval,
hysteresis parameter (Hys), and
activating time offset,
UE ID,
Scenario ID,
Feature ID,
Cell ID,
Site ID,
Zone ID, and
data quality indicator.

In some embodiment, the AI/ML model monitoring configuration is sent in a downlink message comprising a radio resource control (RRC) message, system information, medium access control (MAC) control element (CE), downlink control information (DCI), PDSCH, PDCCH, or LPP message.

In some embodiment, the AI/ML model monitoring configuration is sent in MAC CE, UCI, a radio resource control (RRC) message, physical uplink control channel (PUCCH), physical uplink shared channel (PUSCH), or LTE Positioning Protocol (LPP) message.

The AI/ML model monitoring configuration can be configured by NW or UE. In an embodiment, when AI/ML model monitoring and the configuring are performed in NW, the method further comprises configuring the monitoring configuration for the one or more AI/ML models and/or the LCM for the one or more AI/ML models.

In an embodiment, when the AI/ML model monitoring and decision making for the result of the monitoring are performed by different devices, the method further comprises reporting a result of the model monitoring.

When an AI/ML model monitoring result of the reporting is transmitted in an uplink message, the AI/ML model monitoring result is carried in MAC CE, UCI, a radio resource control (RRC) message, physical uplink control channel (PUCCH), physical uplink shared channel (PUSCH), or LTE Positioning Protocol (LPP) message.

When an AI/ML model monitoring result of the reporting is transmitted in a downlink message, the AI/ML model monitoring result is carried in a radio resource control (RRC) message, system information, medium access control (MAC) control element (CE), downlink control information (DCI). PDSCH, PDCCH, or LPP message.

The AI/ML model monitoring result report may comprise one or more of AI/ML model monitoring report configuration ID, AI/ML model ID, AI/ML model monitoring result, and triggering event of model monitoring reporting.

At least one wireless communication device makes a decision associated with at least one AI/ML model, wherein the decision at least comprises an actions of lifecycle management. The actions of lifecycle management may comprise AI/ML model activation, deactivation, model selection, model switching, or fallback. The decision may be triggered based on a threshold-based approach, a rule-based approach, a ML-based approach, or an expert-system-based approach. The decision may be made by a UE or NW.

The rule-based approach comprises at least one of:
a decision rule is based on a threshold;
a decision rule is based on candidate models;
a decision rule is based on AI/ML model monitoring methods; and/or
a decision rule is predefined or preconfigured; and/or
a decision rule comprises a default rule.

In the rule-based approach, threshold-based decision rules are based on different thresholds defined for different actions of lifecycle management, and/or for different AI/ML model monitoring methods.

In an embodiment, the model monitoring may be triggered by an event where performance of the at least one AI/ML model becomes worse than an AI/ML model performance threshold. In an embodiment, the model monitoring is triggered by an event where performance of the at least one AI/ML model becomes better than an AI/ML model performance threshold.

### Definitions

Definition of terms is listed in the following:

1) Global AI/ML model ID: A Global AI/ML model ID is a unique identifier for an AI/ML model that can be assigned at different levels of granularity, such as global, PLMN-specific, operator-specific, or AI/ML management platform-specific.

2) Logical AI/ML model ID: A Logical AI/ML model ID is a unique identifier for an AI/ML model that is used in the network and that has a mapping relationship with the Global AI/ML model ID. The Logical ID can be assigned at different levels of granularity within the network, such as cell-specific, link-specific, TA-specific, CU-specific, DU-specific, UPF-specific, AMF-specific, RRC-specific, or network-slicing-specific. The term “cell-specific” means that each AI/ML model has a unique ID within a specific cell. Similarly, “link-specific”, “TA-specific”, “CU-Specific”, “DU-specific”, “UPF-specific”, “AMF-specific”, and “network-slicing-specific” mean that each AI/ML model has a unique ID within a specific context in the network.

3) Hardware capability: The hardware capability of the CPU and/or GPU depends on various parameters, such as manufacturer, version, computational performance, number of threads, etc. The computational performance can be measured by metrics such as FLOPS, IPC, memory bandwidth, cache size, clock speed, etc.

4) Software capability: The software capability of the system includes various components, such as manufacturer, version, operating system (OS), application programming interface (API), software development kit (SDK), runtime environment, firmware, compiler, etc.

5) Supported AI capability: The supported AI capability of the system refers to the types of AI/ML models that can be executed on the system, the computing resources and power consumption required for each model, and the file format used for storing or exchanging the models and related data. The types of AI/ML models include convolutional neural networks (CNNs), recurrent neural networks (RNNs), deep belief networks (DBNs), support vector machines (SVMs), random forest, k-nearest neighbors (KNN), naïve Bayes, etc.

6) Real-time performance: The real-time performance of the system involves various indicators, such as CPU/GPU/memory/storage/network usage, temperature, fan speed, power consumption, voltage, error rate of hardware components, response time, thread utilization, etc.

7) Network entity identifier: The network entity must be identified by at least one of the following network entity identifiers:
UE identifier: IMEI (International Mobile Equipment Identity) or UUID; and
RAN identifier: cell ID, physical ID, PLMN, UUID, or another identifier.

8) AI/ML model related information: The AI/ML model related information may include one or more of the following information:
Global AI/ML model ID,
Provider,
Scenario,
Feature.
Function.
Version,
Accuracy,
RRC descriptor,
AI/ML model descriptor,
Compute descriptor,
Storage descriptor, and
Power consumption.

Among the AI/ML model related information, some are detailed in the following.
Scenario: The scenario attribute for an AI/ML model specifies a scenario setting for the AI/ML model. For example, in a scenario, an AI/ML model is used for a certain feature in a FDD massive MIMO system. For example, the scenario attribute can be set to different values that indicate the type of environment for which the AI/ML model is optimized. Some examples of scenario values are indoor, outdoor, flying, water, and mobility speed. These values correspond to environments that have different characteristics.
Feature: The feature attribute may be configured to CSI compression, CSI prediction, beam management, positioning, handover, radio resource management, etc.
Function: The function attribute may be configured to CSI compression, CSI prediction, beam management, positioning, handover, radio resource management, etc. Additionally, the function attribute may be configured to represent usage of the AI/ML model. For example, the function attribute of the AI/ML model may be configured to monitoring, inference, and/or training.
RRC descriptor: The RRC descriptor defines the reference signal configuration and the CSI measurement parameters for the AI/ML model. These parameters include one or more of the following:
   reference signal timing configuration.
   a reference signal frequency configuration.
   reference signal antenna port number, and
   CSI content configuration.
The reference signal timing configuration can include various parameters, such as the duration of each period, the interval between time steps, and the pattern of hopping between different time slots. Similarly, the reference signal frequency configuration can specify different aspects of the frequency domain, such as the allocation of frequency resources, the scheme of hopping between different frequency bands, and so on. The CSI content configuration can determine what kind of information is conveyed by the CSI, such as the channel matrix that describes the channel state, the eigen-vector that represents the dominant direction of the channel, and so on.
AI/ML model descriptor: The AI/ML model descriptor describes the model attributes of the AI/ML model. It includes information such as:
   AI/ML type,
   Accuracy,
   Input data requirement,
   Output data.
   Monitoring method,
   Input data distribution, and/or
   Output data distribution.
Compute descriptor: The compute descriptor specifies the computation resource and the type of CPU or GPU needed for the AI/ML model. It includes information such as:
   Number of CPU cores or GPU units.
   Clock speed,
   Memory bandwidth, and/or
   Cache size.
Storage descriptor: The storage descriptor specifies the storage resource and the type of memory needed for the AI/ML model. It includes information such as:
   Memory size,
   Memory type (e.g., RAM, ROM, flash, etc.),
   Memory access speed, and/or
   Memory latency.
Power consumption: The power consumption attribute describes the amount of power consumed by the AI/ML model's computation. It includes information such as:
   Voltage.
   Current,
   Average power consumption,
   Peak power consumption, and/or
   Power efficiency.

9) Data collection descriptor: The data collection descriptor specifies either one or both of the following: a training data descriptor or a monitoring descriptor.
Training data descriptor: The training data descriptor specifies the data collected for AI/ML model training. It includes one or more of the following: channel information (e.g., real-time channel matrix, long-term channel matrix, CSI, eigen-vector, etc.), system logging information (e.g., computation, storage, memory, etc.).
Monitoring descriptor: The monitoring descriptor describes the input data of monitoring for AI/ML model or LCM, including one or more of the following: inference accuracy, system throughput, spectrum efficiency, NACK ratio, ACK ratio, SINR, RSRP, RSRQ, beam failure, link failure, positioning, intra-cell interference, inter-cell interference, BLER, MSER and FAR, performance loss, performance gain, channel information (e.g., real-time channel matrix, long-term channel matrix, CSI, eigen-vector, etc.), input/output data distribution, and/or applicable condition(s);
Decision descriptor: The monitoring descriptor describes the input data for decision, including model monitoring result.

10) Model monitoring related definition: Model monitoring is a process that helps to achieve certain LCM actions, such as selecting, switching, activating, deactivating, or falling back to different AI/ML models or non-AI modules. The process consists of three steps: collecting relevant monitoring input, performing monitoring calculations to produce output or results, and making a decision based on the output or results. The decision can help to maintain the current AI/ML model. The same or different entities (UE, NW) can perform model monitoring and decision making. FIG. 1 shows the basic flow of the model monitoring procedure.

In the description, AI/ML models may be measured by four model monitoring methods that differ in their criteria and metrics. A brief overview of each method is detailed in the following:
M-Method A: This method monitors an AI/ML model based on inference accuracy of the model. M-Method A measures how well the model predicts the correct outcomes.
M-Method B: This method monitors an AI/ML model based on system performance of the model. System performance includes various indicators such as throughput, spectrum efficiency, NACK ratio, ACK ratio, SINR, RSRP. RSRQ, beam failure, link failure, positioning, intra-cell interference, inter-cell interference, BLER, MSER and FAR.
M-Method C: This method monitors an AI/ML model based on input/output data distribution of the model. M-Method C compares the statistical properties of the data used for training and testing the model.
M-Method D: This method monitors an AI/ML model based on applicable condition(s) of the model. M-Method D specifies the range of scenarios and parameters for which the model is valid and reliable. There are different ways to evaluate changes in system performance. One way is model selection, which involves choosing among models that have similar functions or features based on some criteria. Another way is model switching, which involves switching to a different model that has different features when the current model is not suitable. A third way is fallback, which involves replacing an AI-based method with a traditional non-AI-based method when the AI-based method fails. A fourth way is model updating, which involves re-training or fine-tuning a model to adapt to new data or conditions. These methods are applied depending on the degree of performance deterioration of a monitored AI/ML model. For example, model selection is used when the performance drops slightly, model switching is used when the performance drops moderately, fallback is used when the performance drops significantly, and model updating is used when the model needs to be improved.

### Embodiment 1: Procedure for Model Monitoring

To monitor the AI/ML models on both the UE-side and the NW-side, some information needs to be transmitted over the air interface. This information may include:
AI/ML model monitoring configuration, which specifies the parameters and criteria for monitoring the models;
AI/ML model monitoring activation/deactivation signaling, which indicates when to start or stop the monitoring process;
AI/ML model monitoring result reporting/feedback, which provides the data and metrics collected from the monitoring process;
AI/ML model monitoring decision result reporting/feedback, which conveys the actions and recommendations based on the monitoring results.

These types of information are detailed in the following:
AI/ML model monitoring configuration: The configuration may include one or more of the following information: AI/ML monitoring configuration ID, AI/ML model ID, AI/ML model monitoring object, AI/ML model monitoring metrics. AI/ML model monitoring report configuration, AI/ML model monitoring report configuration ID, AI/ML model monitoring report type, AI/ML model monitoring threshold, AI/ML model monitoring reference signal, AI/ML model monitoring time window, time to trigger, model monitoring reporting amount, monitoring reporting interval, hysteresis parameter (Hys), activating time offset, UE ID, scenario ID, feature ID, Cell ID, site ID, zone ID, and data quality indicator.

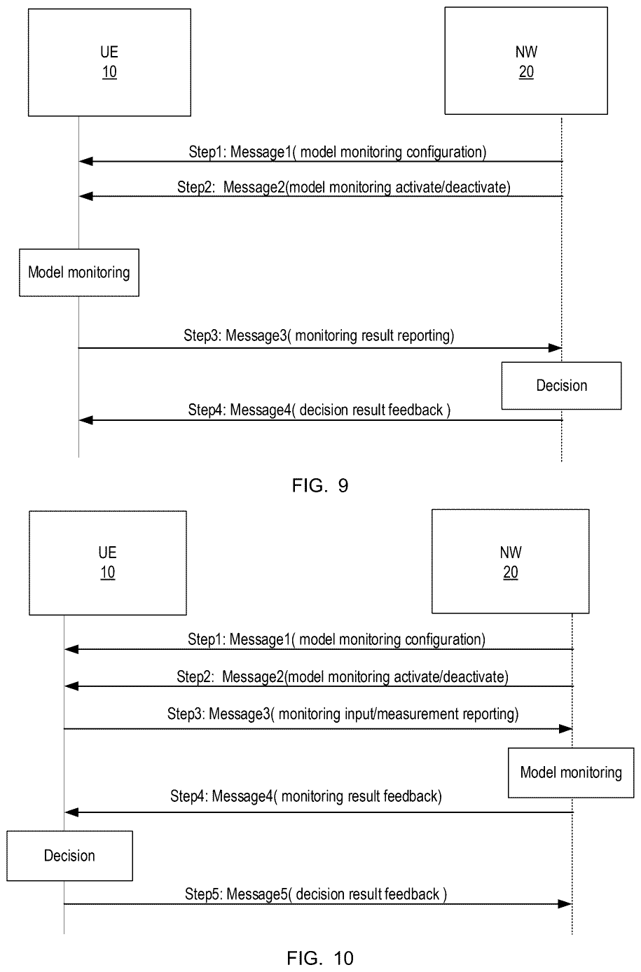

AI/ML model monitoring configuration: The configuration is a set of parameters that specify how to monitor the performance and behavior of an AI/ML model in production. An AI/ML model monitoring configuration may include one or more of the following information: AI/ML monitoring configuration ID, AI/ML model ID, AI/ML model monitoring object, AI/ML model monitoring metrics, AI/ML model monitoring report configuration, AI/ML model monitoring report configuration ID, AI/ML model monitoring report type, AI/ML model monitoring threshold, AI/ML model monitoring reference signal, AI/ML model monitoring time window, time to trigger, model monitoring reporting amount, monitoring reporting interval, hysteresis parameter (Hys), activating time offset, UE ID, scenario ID, feature ID, Cell ID, site ID, zone ID, and data quality indicator.
AI/ML monitoring configuration ID: a unique identifier that links an AI/ML monitoring object to an AI/ML model monitoring report configuration. This ID specifies the monitoring configuration for a given AI/ML model.
AI/ML model ID: an identifier that can be one or more of the following: Logical model ID, Global model ID, and/or an identifier of AI/ML model related information related to the AI/ML model. The AI/ML model ID is included in the AI/ML model activate/deactivate information and/or in the model selection/switching/model identification information.
AI/ML model monitoring object: a specific monitoring object that corresponds to a specific AI/ML model and/or a specific LCM action (e.g., deactivation/activation, selection, switching, fallback).
AI/ML model monitoring metrics: The AI/ML model monitoring metrics are indicators of various aspects of the model's performance and behavior, such as system performance, inference accuracy, input data distribution, output data distribution, applicable condition, etc.
AI/ML model monitoring report configuration: A configuration which specifies what information will be reported for the model monitoring, such as ground-truth CSI/decoding/measurement information, the loss/gain of performance, the loss/gain of inference accuracy, the loss/gain of input data distribution, the loss/gain of output data distribution, the loss/gain of applicable condition, or the direct value of AI/ML model's measurement (e.g., system performance, inference accuracy, input data distribution, output data distribution, applicable condition).
AI/ML model monitoring report configuration ID: a unique identifier for the configuration of the AI/ML model monitoring report. The configuration is referred to as AI/ML model monitoring report configuration.
AI/ML model monitoring report type: a parameter that specifies the type of AI/ML model monitoring report (for example, periodic or event-triggered).
AI/ML model monitoring threshold: a value or range of values that defines the acceptable performance of the AI/ML model, as described in embodiment 2 and/or embodiment 3.
AI/ML model monitoring reference signal: a signal that contains information about the AI/ML model, such as the AI/ML model ID, the time/frequency configuration (periodic, aperiodic, semi-static), etc.;
AI/ML model monitoring time window: a parameter that indicates the duration of the AI/ML model monitoring, which includes at least one of: starting time, time duration, or a time offset.
Trigger time: Time during which specific criteria for the event needs to be met in order to trigger an AI/ML model monitoring reporting.
Model monitoring report amount: The number of model monitoring reports generated for event-triggered and/or periodic model monitoring report types.
Monitoring report interval: The time gap between successive periodic reports for event-triggered and/or periodic model monitoring report types.
Hysteresis (Hys): A hysteresis parameter. The parameter used to control the sensitivity of model monitoring events.
Activation time offset: The activation time offset specifies a time offset after which the reference signaling, the AI/ML model, or the LCM function is activated for model monitoring. The offset may be applied to a reception time of a message (e.g., message 1 in FIGS. 9 to 12).
UE ID: An indication of user equipment
Scenario ID: An indication of scenario
feature ID: An indication of feature
Cell ID: An indication of cell
Site ID: An indication of site
zone ID: An indication of zone
Data quality indicator: which is used to indicate the data quality. The data quality indicator can be based on latency, data size, scenario, feature, cell, site, and/or zone
AI/ML model monitoring activation and deactivation signaling: The signaling includes one or more of: AI/ML model monitoring threshold, AI/ML model monitoring object, activating time, and deactivating time. The signaling is detailed in Embodiment 4. AI/ML model monitoring events are detailed in embodiment 2.
AI/ML model monitoring threshold, as defined in embodiment 2 and/or embodiment 3, that determines the acceptable range or limit for the model performance or behavior.
AI/ML model monitoring object, which specifies the particular model and/or lifecycle management (LCM) process (such as activation, selection, switching, fallback) that is subject to monitoring and signaling.
Activation time, which indicates when the signaling or the model or the LCM action is activated or started.
Deactivation time, which indicates when the signaling or the model or the LCM action is deactivated or stopped.
AI/ML model monitoring result reporting: which is used for model monitoring result synchronization among entities in network and carried by uplink channel or downlink channel. In the AI/ML model monitoring result reporting, an AI/ML model monitoring result report comprises one or more of AI/ML model monitoring report configuration ID, AI/ML model ID, AI/ML model monitoring result, and triggering event of model monitoring reporting.
AI/ML monitoring reporting configuration ID: The ID is used to identify a configuration of the AI/ML model monitoring reporting that reports AI/ML model monitoring results.
AI/ML model ID: The ID can be one or more of a logical model ID, global model ID, and/or an Identifier of AI/ML model related information. The AI/ML model ID is carried in AI/ML model active/deactivate information.
AI/ML model monitoring result: The result may comprise one or more of the following:
   Option A: The AI/ML model that has the highest performance score (defined by the AI/ML model monitoring configuration), identified by a unique Logical AI/ML model ID, or other information related to the AI/ML model, or an RRC-specific indicator.
   Option B: The top N AI/ML models with or without their performance metrics, which could include the loss/gain/original value of various aspects of performance (e.g., system performance, inference accuracy, input data distribution, output data distribution, applicable condition, etc.).
   Option C: The ground-truth of the AI/ML model, such as the non-AI based CSI information, or PDSCH decoding information.
Triggering event of model monitoring reporting: it is used to indicate which event trigger the AI/ML model monitoring result reporting, examples of the event are described in embodiment 2.

To facilitate monitoring of the decision result of an AI/ML model, the decision result includes the following information or signaling: the above defined AI/ML model monitoring active/deactivation signaling of the AI/ML model, the model ID, and the LCM actions as defined above.

In the description, an AI/ML model being monitored can be referred to as a monitored AI/ML model. A module that performs model monitoring can be referred to as a monitoring agent. A module that makes a decision to recommend or trigger an LCM action based on the result of the model monitoring can be referred to as a decision agent. Each of the monitored AI/ML model, monitoring agent, and decision agent and can be deployed in UE (e.g., UE 10), or BS. (e.g., NW 20). A model or agent deployed on a device means that the model or agent is installed on and executed by the device.

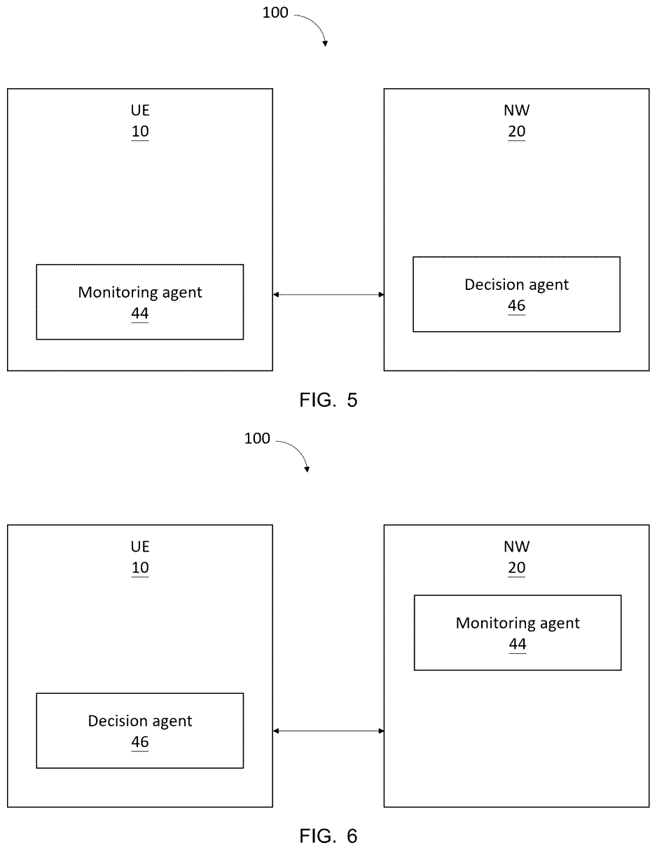

With reference to FIGS. 5, 6, 7, and 8, each of monitored AI/ML model, monitoring agent 44, and decision agent 46 can be deployed in UE (e.g., UE 10), or BS (e.g., NW 20). A network entity (e.g., UE 10 or NW 20) with a monitored AI/ML model can be referred to as a monitored network entity. A network entity (e.g., UE 10 or NW 20) with a monitoring agent can be referred to as a monitoring network entity. A network entity (e.g., UE 10 or NW 20) with a decision agent can be referred to as a decision network entity. As can be appreciated, a UE (e.g., UE 10) can serve as a sole monitored network entity, or a combination of a monitored network entity, a monitoring network entity, and a decision network entity. Similarly, a BS (e.g., NW 20) can serve as a sole monitored network entity, or a combination of a monitored network entity, a monitoring network entity, and a decision network entity.

To avoid redundantly repeating the terms, in the description, an AI/ML-model-assisted operation can be interpreted as being performed by monitored AI/ML model(s) and/or the monitored network entity. A recommended or triggered LCM action can be interpreted as being performed for monitored AI/ML model(s) and/or the monitored network entity.

In the description, model monitoring operations can be interpreted as being performed by monitoring agent (e.g., 44) and/or the monitoring network entity.

In the description, a decision operation for recommending or triggering an LCM action can be interpreted as being performed by decision agent (e.g., 46) and/or the decision network entity.

The following sections illustrates some example scenarios and procedures based on the aforementioned information or signaling and describes the expected behavior of the UE and NW (BS and/or CN) in each scenario.

### Scenario 1: Model Monitoring in UE Side and Decision in NW Side.

With reference to FIG. 5, and monitoring agent 44 are deployed in UE (e.g., UE 10), and decision agent 46 is deployed in NW (e.g., NW 20).

FIG. 9 illustrates a model monitoring procedure in an embodiment when model monitoring is performed on UE side, and decision is performed on NW side. The model monitoring procedure may be used to UE-sided model, NW-sided model, and/or two-sided model and is detailed in the following:

Step1: NW sends to UE a message 1 for AI/ML model monitoring configuration. The message 1 may include one or more types of the following information: AI/ML monitoring configuration ID, AI/ML model ID, AI/ML model monitoring measurement object, AI/ML model monitoring metrics, AI/ML model monitoring report configuration, AI/ML model monitoring report configuration ID, AI/ML model monitoring report type, AI/ML model monitoring threshold, AI/ML model monitoring reference signal, AI/ML model monitoring time window, time to trigger, model monitoring reporting amount, monitoring reporting interval, Hys, activating time offset, UE ID, scenario ID, feature ID, Cell ID, site ID, zone ID, and data quality indicator. The message 1 can be a dedicated RRC message, and/or MAC-CE, and/or system information;

Step2: Optionally, NW sends to UE a message 2, which is used to deactivate/activate AI/ML model monitoring reference signals, or AI/ML model related measurement (e.g., AI-specific measurement and/or legacy measurement, where the measurement can be L1-measurement, L3-measurement, new defined measurement). The message 2 includes one or more types of the following information: AI/ML model ID, AI/ML model monitoring objects, activate time, deactivate time. The message 2 may carried in MAC CE, DCI, RRC message, PDCCH, PDSCH etc.

Step 2′, Alternatively, if inference is deployed in NW side, NW may send inference output to UE by MAC CE, or DCI, or RRC message, or PDCCH, or PDSCH etc.

Step3: UE sends to NW a message 3 to report the model monitoring calculation result. The message 3 includes one or more types of the following information: AI/ML monitoring reporting configuration ID, AI/ML model ID, AI/ML model monitoring result, and triggering event of model monitoring reporting. The message 3 may be carried in RRC message, PUSCH, PUCCH, UCI, MAC CE and etc.

Step4: NW sends to UE a message 4, which is used to notify/recommends UE the decision result, such as activation, or deactivation, or model selection, or model switching, or fallback, the decision result based on the receiving model calculation result in step3 and decision rule. This message includes at least one of the following: model ID, LCM actions, the AI/ML model monitoring activate/deactivation signaling, activate time, deactivation time. The message 4 can be carried in RRC message, PDSCH, PDCCH, DCI, MAC CE etc.

### Scenario 2: AI/ML Model Monitoring Calculation in NW Side and Decision in UE Side:

With reference to FIG. 6, the decision agent 46 are deployed in UE (e.g., UE 10), and monitoring agent 44 is deployed in NW (e.g., NW 20).

FIG. 10 illustrates the model monitoring procedure in an embodiment when AI/ML model monitoring is performed on NW side, and decision is performed on UE side, which can be applied to UE-sided model, NW-sided model, and/or two-sided model. The potential procedure is shown in the following:

Step1: NW sends to UE a message 1, which is used for AI/ML model monitoring configuration. The step is similar to scenario1-step1. Additionally, a decision rule may also be included in the message. The message 1 can be carried in a dedicated RRC message, or MAC CE, system information;

Step2: Optionally, NW sends to UE a message 2, which is used to deactivate/activate AI/ML model monitoring signaling, or AI/ML model related measurement. The step is similar to scenario1-step2. The message 2 may be MAC CE, DCI, RRC message, etc.

Step3: UE sends to NW a message 3, which is the input for model monitoring, such as ground truth, legacy/AI-specific measurement reporting. The message3 may be carried in RRC message, UCI, PUSCH, PUCCH etc.

Step4: NW sends to UE a message 4, which is the output of model monitoring, such as the AI/ML model with the best performance, best N AI/ML models with or without the associated measurement results. The message 4 may be carried in RRC message, DCI, PDSCH, PDCCH etc.

Step5: UE sends to NW a message 5, which is used to notify/recommends NW the decision result, such as activation, or deactivation, or model selection, or model switching, or fallback, the decision result based on the receiving model calculation result in step4 and decision rule. The message 5 is similar to scenario1-step4 and can be carried in RRC message, PUSCH, PUCCH, UCI. MAC CE etc. Or, message 5 just is an ACK/NACK from UE to NW, which indicates whether the UE receives the monitoring result successfully or not;

### Scenario 3: AI/ML Model Monitoring Calculation and Decision in UE Side

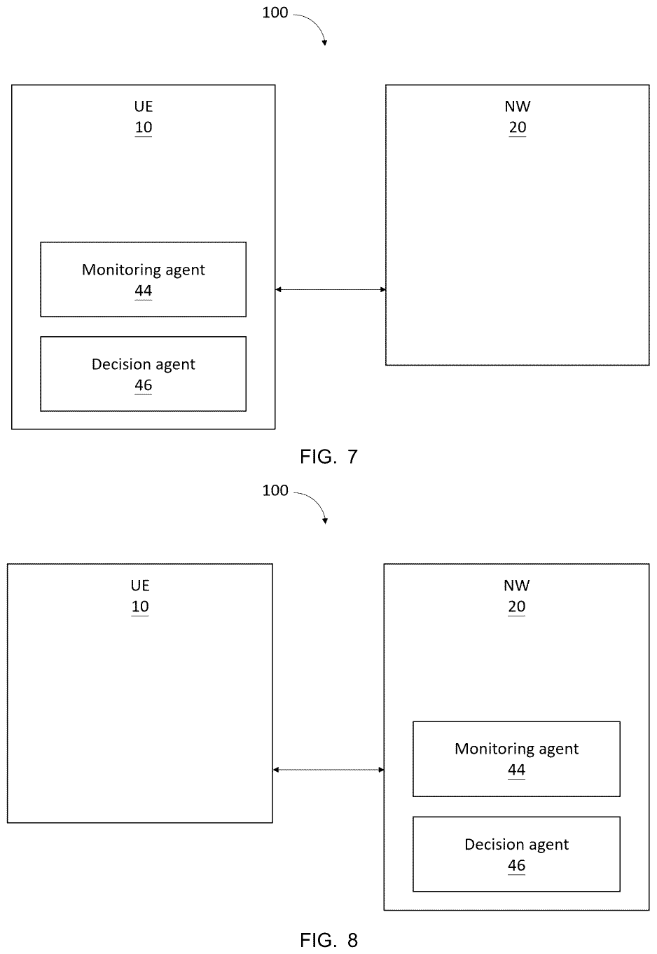

With reference to FIG. 7, monitoring agent 44, and decision agent 46 are deployed in UE (e.g., UE 10).

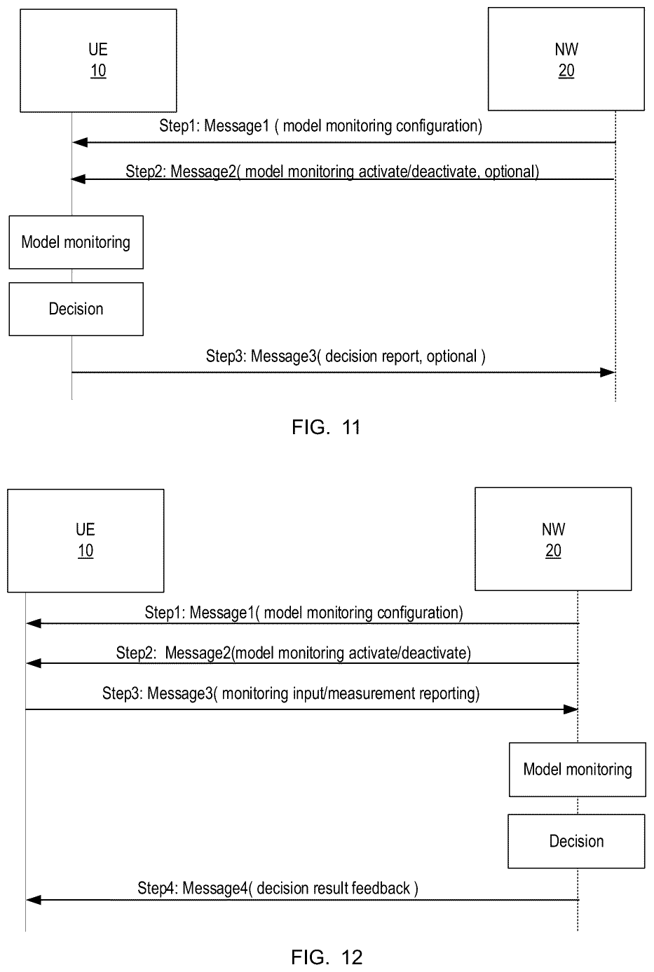

FIG. 11 illustrates the model monitoring procedure in an embodiment when AI/ML model monitoring and decision deployed in UE side, which can be applied to UE-sided model, NW-sided model, and/or two-sided model. The potential procedure is shown in the following:

Step1: NW sends to UE a message 1, which is used for AI/ML model monitoring configuration. The step is similar to scenario1-step1. Additionally, a decision rule may also be included in the message. The message 1 can be carried in a dedicated RRC message, MAC-CE, or system information;

2) Step2: Optionally, NW sends to UE a message 2, which is used to deactivate/activate AI/ML model monitoring signaling, or AI/ML model related measurement. The step is similar to scenario1-step2. The message 2 may be MAC CE, DCI, RRC message, PDCCH, PDSCH, etc.

Step3: Optionally, UE sends to NW a message 3, which is used to notify/recommends NW the decision result, such as activation, or deactivation, or model selection, or model switching, or fallback, the decision result based on the receiving model calculation result in step2 and decision rule. The step is similar to scenario1-step4. The message 3 can be RRC message, PUSCH, PUCCH, UCI, MAC CE etc. Or, message 3 just is an ACK/NACK from UE to NW, which indicates the UE receives the activate/deactivate signaling successfully or not.

### Scenario 4: AI/ML Model Monitoring Calculation and Decision in NW Side:

With reference to FIG. 8, the monitoring agent 44 and decision agent 46 are deployed in NW (e.g., NW 20).

FIG. 12 illustrates the model monitoring procedure in an embodiment when AI/ML model monitoring and decision deployed in NW side, which can be applied to UE-sided model, NW-sided model, and/or two-sided model. The potential procedure is shown in the following:

Step1: NW sends to UE a message 1, which is used for AI/ML model monitoring configuration. The step 1 is similar to scenario1-step1. The message 1 can be carried in a dedicated RRC message, or MAC CE, or system information;

Step2: Optionally, NW sends to UE a message 2, which is used to deactivate/activate AI/ML model monitoring signaling, or AI/ML model related measurement. The step is similar to scenario1-step2. The message2 may be MAC CE, DCI, RRC message, PDCCH, PDSCH etc.

Step3: UE sends to NW a message 3, which is the input for model monitoring, such as ground truth, legacy/AI-specific measurement reporting. The message 3 may be UCI, RRC message, PUCCH, PUSCH etc.

Step4: Optionally, NW sends to UE a message 4, which is used to notify/recommends UE the decision result, such as activation, or deactivation, or model selection, or model switching, or fallback, the decision result based on the receiving model calculation result in step2 and decision rule. The step is similar to scenario1-step4. The message 4 can be RRC message, PUSCH, PUCCH, UCI, MAC CE, etc.

In some examples, in order to achieve a better LCM working efficiency to improve the system performance, model monitoring needs to monitor one or more than one AI/ML models. However, determining which AI/ML models are needed be monitored is not clear, the related solutions are shown below:

### If Model Monitoring is Deployed at UE Side:

Sol #1: The AI/ML models for model monitoring can be determined by NW configuration. More specifically, NW sends to UE a message for assisting on AI/ML model selection. The message may include one or more types of the following information: model ID, feature, scenario, functions, activate/deactivate signaling, activating time, deactivating time, time window. The message can be a dedicated RRC message, MAC CE, DCI. PDSCH, PDCCH, LPP message.

Sol #2: The AI/ML models for model monitoring can be determined according to UE implementation.

### If Model Monitoring is Deployed at NW-Side:

Sol #1: The AI/ML models for model monitoring can be determined by UE request/UE capability reporting. More specifically, UE sends to NW a message for assisting to select AI/ML models. The message may include one or more types of the following information: model ID, feature, scenario, functions, activate/deactivate signaling, activating time, deactivating time, time window, UE storage, and UE hardware capability. The message can be UE assistant information, dedicated RRC message, MAC CE, UCI, PUSCH, PUCCH, LPP message.

Sol #2: The AI/ML models for model monitoring can be determined by NW implementation;

In some examples, among the AI/ML models for model monitoring, inevitably, some of these AI/ML models are active and some of these AI/ML models are inactive. However, one challenge for model monitoring is how to determine and activate the inactive/unused AI/ML models. The options used to determine and activate the inactive/unused AI/ML models are detailed in the following:

Sol #1: The inactive/unused AI/ML models are determined and activated using a activate message. The message may include one or more types of the following information: model ID, feature, scenario, functions, activating time, deactivating time, time window, site, and zone. The message can be MAC CE, DCI, UCI, system information, PUCCH, PUSCH, PDCCH, PDSCH;

Sol #2: The inactive/unused AI/ML models are determined and activated using a monitoring configuration information message. Once UE receives this message, according to its information, the AI/ML model can be activated. The monitoring configuration information message may include one or more of the following information: model ID, feature, scenario, functions, activating time, deactivating time, time window, site, zone, the message can be MAC CE, DCI, system information, PDCCH, PDSCH;

Sol #3: The inactive/unused AI/ML models are determined and activated are predefined or fixed or defined randomly. The inactive/unused AI/ML models are determined and activated are determined based on some rule, such as activating time and a number of activating AI/ML models.

### Embodiment 2: Event-Based Model Monitoring

To minimize the over the air (OTA) overhead and/or air interface overhead, an embodiment of the disclosure provides a method of event-triggered AI/ML model monitoring. The model monitored includes AI/ML model and AI-specific LCM actions. The AI/ML model monitoring involves reporting for the monitoring. This method is activated by specific events that are defined in advance.

The criteria for activating the monitoring should be specified. Here are some possible events. At least two kinds of AI/ML model monitoring events are defined in the description. The AI/ML model performance can be measured by M-Method A, M-Method B, M-Method C, M-Method D, or other methods. The AI/ML model performance threshold can be based on inference accuracy, system performance, data distribution, or applicable condition.

Event A1: (AI/ML Model Performance Becomes Worse than AI/ML Model Performance Threshold)

Event A1 refers to the situation where the system detects a performance degradation and triggers one of the following actions: deactivating the AI/ML model, selecting a different AI/ML model, switching to another AI/ML model, or falling back to a non-AI-based module (or non-AI-based scheme).

The entering condition of the event is satisfied when condition A1-1, as specified below, is fulfilled: Inequality A1-1 (Entering condition):

$$Ms + Hys < Thresh$$

The leaving condition of the event is satisfied when condition A1-2, as specified below, is fulfilled; Inequality A1-2 (Leaving condition)

$$Ms - Hys > Thresh$$

The variables in the formula are defined as follows:
Ms: The variable refers to the AI/ML model performance loss. Ms can be calculated with two methods, illustrated as Option A and Option B.
   Option A: Ms is calculated based on the AI/ML model's output (undergoing/new candidate AI/ML model) and ground truth, not taking into account any offsets. The ground truth means a non-AI/ML model used here. For example, Ms is calculated by monitoring functions or an AI/ML model which is dedicated for AI/ML model's monitoring. Measurement result obtained by the monitored AI/ML model may be adjusted by a measurement object specific offset to form the output of the monitored AI/ML model. The measurement object specific offset is specific to the AI/ML model and/or specific LCM action (activation, selection, switching, fallback).
   Option B: Ms is calculated by the AI/ML model's input (undergoing/new candidate AI/ML model) and ground truth. The ground truth means a non-AI/ML model used here, the ground truth mean non-AI/ML model used here; For example, Ms is calculated by monitoring functions or an AI/ML model which is dedicated for AI/ML model's monitoring. Measurement result obtained by the monitored AI/ML model may be adjusted by a measurement object specific offset to form the output of the monitored AI/ML model. The measurement object specific offset is specific to the AI/ML model and/or specific LCM action (activation, selection, switching, fallback).
Thresh: The parameter Thresh is the threshold parameter for the event A1. The threshold parameter depends on model monitoring methods and may be AI/ML model specific.
Hys: The parameter Hys is a hysteresis parameter for this event A1. The hysteresis parameter (Hys) may be configured by RRC signaling, including the reporting configuration or AI/ML model monitoring configuration or other signaling.
   Event A2: (AI/ML Model Performance Becomes Better than AI/ML Model Performance Threshold)

Event A2 refers to the situation where the system detects a performance increase and triggers one of the following actions: deactivating the AI/ML model, selecting a different AI/ML model, switching to another AI/ML model, or falling back to a non-AI-based module (or non-AI-based scheme).

The entering condition of the event is satisfied when condition A2-1, as specified below, is fulfilled: Inequality A2-1 (Entering condition):

$$Ms - Hys < Thresh$$

The leaving condition of the event is satisfied when condition A2-2, as specified below, is fulfilled; Inequality A2-2 (Leaving condition):

$$Ms + Hys > Thresh$$

The variables in the formula are defined as follows:
Ms: The variable refers to the AI/ML model performance gain. Ms can be calculated with two methods, illustrated as Option A and Option B.
   Option A: Ms is calculated based on the AI/ML model's output (undergoing/new candidate AI/ML model) and ground truth, not taking into account any offsets. The ground truth means a non-AI/ML model used here. Measurement result obtained by the monitored AI/ML model may be adjusted by a measurement object specific offset for the AI/ML model to form the output of the monitored AI/ML model.
   Option B: Ms is calculated based on the AI/ML model's input (undergoing/new candidate AI/ML model) and ground truth, not taking into account any offsets. The ground truth means a non-AI/ML model used here. Measurement result obtained by the monitored AI/ML model may be adjusted by a measurement object specific offset for the AI/ML model to form the output of the monitored AI/ML model.
Thresh: The parameter Thresh is the threshold parameter for the event A2. The threshold parameter depends on model monitoring methods and may be AI/ML model specific.
Hys: The parameter Hys is a hysteresis parameter for this event A2. The hysteresis parameter (Hys) may be configured by RRC signaling, including the reporting configuration or AI/ML model monitoring configuration or other signaling.

### Embodiment 3: AI/ML Model LCM Determination in Response to Model Monitoring

To improve the working efficiency of LCM, model monitoring can trigger various actions of LCM, such as activation, deactivation, selection, switching, and fallback. However, Since these LCM actions may be applied to different situations, a decision rule is needed to entities to choose the appropriate LCM actions based on the model monitoring results. Some possible options for designing a decision rule are:
Threshold-based approach: This approach sets specific thresholds for the model monitoring output and triggers the LCM action accordingly. For example, a monitored model may need to be deactivated if the monitoring output of the model exceeds a certain threshold.
Rule-based approach: This approach defines a set of rules based on the model monitoring output and takes action based on those rules. For example, a monitored model may need to be switched if the monitoring output of the monitored model indicates a high level of interference.
Machine learning-based approach: This approach involves training a machine learning model to predict the appropriate LCM action based on the monitoring output of the monitored model. This approach can be useful when the decision-making process is complex and requires a lot of data.
Expert system-based approach: This approach involves using an expert system that has a set of rules and knowledge base to determine an appropriate LCM action based on the monitoring output of the monitored model. This approach is useful when there is a lot of domain-specific knowledge available.

### Alternative1: Decision Rule Based on a Defined Threshold:

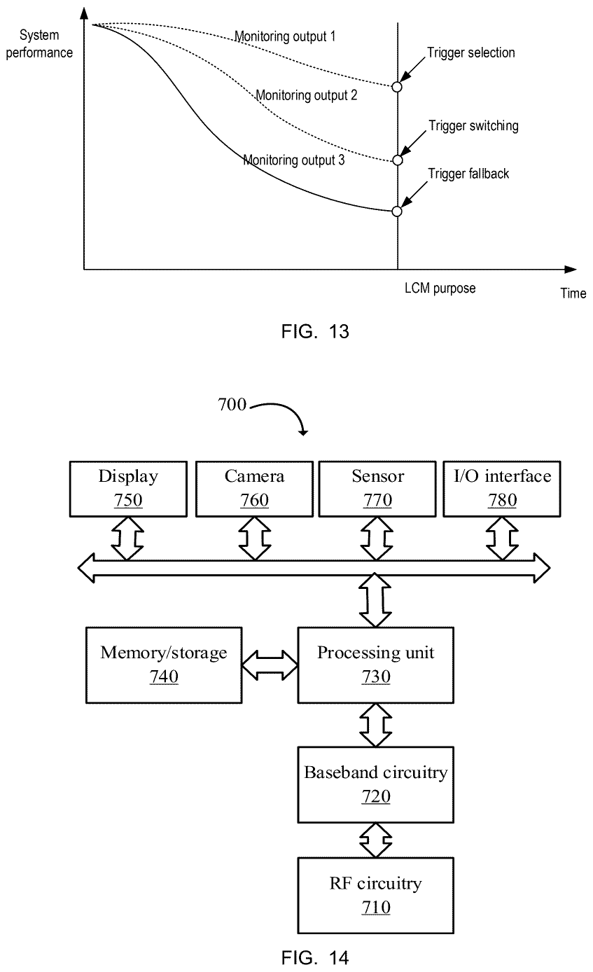

Based on any of the monitoring methods, once monitoring output indicates the system performance becomes worse, it is possible to trigger an LCM action, such as model selection, model switching, fallback and model update. In order to determine which LCM action is enabled, different thresholds @ are defined for different LCM actions and monitoring methods. Thus, each threshold @ is LCM action specific and/or monitoring method specific. Table 2 and FIG. 13 shows an example of specific thresholds for each LCM action based on different model monitoring methods.

TABLE 2
Threshold Φ for LCM action and model monitoring method

| | M-Method | M-Method | M-Method | M-Method |
|---|---|---|---|---|
| | A | B | C | D |
| Model selection | Φ₁₋₁ | Φ₂₋₁ | Φ₃₋₁ | null |
| Model switching | Φ₂₋₁ | Φ₂₋₂ | Φ₂₋₃ | Φ₂₋₄ |
| Fallback | Φ₃₋₁ | Φ₃₋₂ | Φ₃₋₃ | Φ₄₋₄ |

Alternative 2: Decision rule based on candidate models:

The decision rule may vary depending on the available candidate models. If one or more candidate models are available, the decision rule may give preference to or prioritize LCM actions of model selection and model switching when recommending or triggering a model.

If the candidate model has the same AI/ML feature as the current deployed AI/ML model, the decision rule will favor recommending model selection.

If the candidate model has a different AI/ML feature from the current deployed AI/ML model, the decision rule will favor recommending model switching.

If the candidate model supports multiple AI/ML features, one of which is the same as the current deployed AI/ML model and one of which is different, the decision rule will randomly recommend either model selection or model switching.

Otherwise, if there are no candidate models, the decision rule will prioritize recommending fallback.

### Alternative 3: Decision Rule Based on Model Monitoring Methods.

The decision rule may depend on the model monitoring methods. For example, when the monitoring network entity use a monitoring method selected from the M-Methods A, B, C, or D to perform AI/ML model monitoring, the decision network entity recommends or triggers an LCM action based on a decision rule of the Alternative 3 associated with the selected monitoring method. The decision rule may be defined for the M-Methods A, B, C, or D. For example:

For M-Method A, B, or C, the decision network entity follows the decision rule to randomly recommends or triggers one of the following actions: model selection, model switching, or fallback.

For M-Method D, the decision network entity follows the decision rule to prioritizes model switching and fallback in the model recommending or triggering. The LCM action may still be chosen randomly. Additionally, when any candidate AI/ML model is available, the decision rule prioritizes model switching over other LCM actions.

### Alternative 4: Predefined or Preconfigured Decision Rule:

The decision rule is predefined or pre-configured. A predefined or pre-configured decision rule prioritizes one LCM action over the others according to a predefined or pre-configured sequence when recommending an LCM action. Some examples of the pre-configured sequence comprise Opt1 to Opt6:
Opt1: model selection, model switching, and fallback.
Opt2: model selection, fallback, and model switching.
Opt3: model switching, model selection, and fallback.
Opt4: model switching, fallback, and model selection.
Opt5: fallback, model selection, and model switching.
Opt6: fallback, model switching, and model selection.

### Alternative 5: Default Rule for the AI/ML Models:

The disclosed method may be performed based on default rules. A default rule specifies that an LCM action is triggered in response to a specific occasion. For example, the AI/ML system will switch (I.e., fallback) to a non-AI/ML working model in the following scenarios:
Link failure: According to a default, if the system (e.g., the monitoring network entity or he model-deployed network) detects a link failure, the model-deployed network entity stops using AI-based processes and revert to non-AI/ML models.
Handover: According to a default, if the system (e.g., the monitoring network entity or he model-deployed network) detects a handover for a UE, the model-deployed network entity uses non-AI/ML models for all processes until the handover is complete,
Random Access: According to a default, if the system (e.g., the monitoring network entity or he model-deployed network) detects that a UE performs random access, the model-deployed network entity either uses non-AI/ML models or disables AI-based processes until the UE terminates random access.

### Embodiment 4: Active or Deactivate the AI/ML Model

An embodiment illustrates how the UE and network can activate or deactivate the AI/ML model for specific purposes, such as CSI compression, CSI prediction, beam management, or positioning. The following paragraphs show the AI/ML model Activate/Deactivate signaling and configuration information.

1) AI/ML model activation/deactivation information: this information is used to activate or deactivate a specific AI/ML model and is carried by downlink or uplink transmission signaling. The signaling can be UE capability reporting, PUCCH, PUSCH, PDCCH, PDSCH, MAC-CE or RRC signaling. The AI/ML model activation/deactivation information may include one or more of the following elements: AI/ML model ID, activate/deactivate information, activate timing, deactivate timing, timing window.
AI/ML model ID: a unique identifier that can refer to one or more of the following:
   Logical AI/ML model ID,
   Global AI/ML model ID, and
   An Identifier of AI/ML model-related information.
Activate/Deactivate information: a value that indicates whether an AI/ML model with the AI/ML model ID is active or inactive. The value can be represented by a Boolean (true or false), a string (such as “on” or “off”), or a bitmap (a sequence of bits). The implementation details are described below:
   Option A-Direct Activate/Deactivate: Each bit may correspond to a specific feature, function, or model ID. If the bit is set to 1, it means that the corresponding item is active; otherwise, it is inactive. For example, if the bit for a scenario (e.g., a scenario-A) is 1, then scenario-A is activated; otherwise, it is deactivated. The same applies to other items, such as feature, function, and model ID.
   Option B-Hierarchical Activate/Deactivate: Each bit corresponds to a group of features, functions, or model IDs that share a common property or characteristic. The items are bonded by a hierarchical relationship(s) as a group. If the bit is set to 1, it means that all the items in the group are activated to an active state; otherwise, if the bit is set to 0, it means that all the items in the group are deactivated to an inactive state. The hierarchical scheme applies to activation and deactivation. If any hierarchical relationship is present between multiple items, the activation by the hierarchical scheme can reduce the indication overhead. For example, if Scenario #1 contains Feature #1 and Feature #2, and Feature #1 contains Function #1 and Function #2, while Feature #2 contains Function #3 and Function #4, and so on. If Scenario #1 is activated/deactivated, all the features, functions, and model IDs contained in Scenario #1 will be activated/deactivated. If both Scenario #1 and Feature #1 are activated/deactivated, all the function and model IDs contained in Scenario #1 and Feature #1 will be activated/deactivated. The hierarchical scheme applies to activation and deactivation.
Activation time: The network entity (e.g., UE) will activate and start running the AI/ML model after the configured activation time.
Deactivation time: The network entity (e.g., UE) will deactivate and stop running the AI/ML model after the configured deactivation time.

Time window: A time window specifies the fixed duration of time for executing the AI/ML model.

2) If the “AI/ML model activate/deactivate information” is transmitted on the uplink channel from a UE or to a NW, the NW will provide the UE with configuration comprising one or more of following information. The UE may perform the operations in response.
AI/ML model ID: a unique identifier that can refer to one or more of the following:
   Logical AI/ML model ID,
   Global AI/ML model ID, and
   An identifier of AI/ML model-related information.

The AI/ML model ID is carried in AI/ML model activate/deactivate information.
Reference signal information configuration: The parameters that specify the time-frequency allocation, duration, and activation of the reference signal for the AI/ML model ID. In addition, the reference signals referred may include CSI-RS, SRS, DMRS, PTRS, etc.
CSI reporting information configuration: The configuration for CSI measurement that is required for the AI/ML model ID includes measurement events, channel state information (CSI) reporting intervals, and other related information.
Activation time: The network entity (e.g., UE) will activate and start running the AI/ML model after the configured activation time.
Deactivation time: The network entity (e.g., UE) will deactivate and stop running the AI/ML model after the configured deactivation time.
Time window: A time window specifies the fixed duration of time for executing the AI/ML model.

3) If the “AI/ML model active/deactivate information” is transmitted on the downlink channel from a NW or to a UE, the UE may perform the operations in response. Some examples of the operations are provided in the following.
When receiving an activation signal, the UE initiates the procedures related to the AI/ML model (e.g., an AI/ML model for CSI measurement, CSI reporting, etc.), according to the RRC configuration that corresponds to the AI/ML model ID that was configured.
When receiving a deactivation signal, the UE terminates the procedures related to the AI/ML model (e.g., an AI/ML model for CSI measurement, CSI reporting, etc.), according to the RRC configuration that corresponds to the AI/ML model ID that was configured.

### Embodiment 5: AI/ML Model Specific Reference Signal Related Procedures

For the reference signal configuration, different types of reference signals are used for different purposes. For example, CSI-RS is used for downlink channel state information (CSI) acquisition and reporting. The UE needs to be configured with both the CSI-RS resource configuration and the corresponding CSI reporting configuration. For SRS, which is used for uplink CSI measurement, the UE needs to be configured with the SRS resource configuration. Other reference signals include DMRS, PTRS, SSB, etc. If an AI/ML model is used in the system, the reference signal related procedures would be enhanced as follows. Configuration for AI/ML model reference signal related procedures would include one or more of the following:
AI/ML model ID: The ID can be logical AI/ML model ID, global AI/ML model ID, and/or an identifier of AI/ML model related information.
Reference signal information configuration: The parameters that specify the time-frequency allocation, duration, and activation of the reference signal for the AI/ML model ID.
CSI reporting information configuration: The configuration for CSI measurement that is required for the AI/ML model ID includes measurement events, channel state information (CSI), reporting intervals, and other related information.

FIG. 14 is a block diagram of an example system 700 for wireless communication according to an embodiment of the present disclosure. Embodiments described herein may be implemented into the system using any suitably configured hardware and/or software. FIG. 14 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that can be adopted in 3GPP specification to create an end product.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random-access memory (RAM), a floppy disk, or other kinds of media capable of storing program codes.

This disclosure proposes a method of monitoring the AIML model between the user equipment (UE) and the network (gNB, LMF, etc.), which can reduce the signaling overhead and enhance the system performance. The method involves sending and receiving model monitoring requests and responses between the UE and the network and updating the AI/ML model accordingly.

Embodiments of the disclosure describe a comprehensive method for monitoring the performance and quality of AI/ML models throughout their life cycle management (LCM), which is an aspect that the current research does not address.

The disclosure enhances AI/ML models for wireless communication systems.

While the present disclosure has been described in connection with what is considered the most practical and preferred embodiments, it is understood that the present disclosure is not limited to the disclosed embodiments but is Intended to cover various arrangements made without departing from the scope of the broadest interpretation of the appended claims.

1. A model management method for artificial intelligence (AI)/machine learning (ML), executable in at least one wireless communication device, comprising:
performing AI/ML model monitoring for one or more AI/ML models and/or lifecycle management (LCM) for the one or more AI/ML models according to AI/ML model monitoring configuration.

2. The model management method of claim 1, further comprising:
reporting a result of the model monitoring.

3. The model management method of claim 2, wherein when an AI/ML model monitoring result of the reporting is transmitted in an uplink message, the AI/ML model monitoring result is carried in MAC CE, UCI, a radio resource control (RRC) message, physical uplink control channel (PUCCH), physical uplink shared channel (PUSCH), or LTE Positioning Protocol (LPP) message; or
when an AI/ML model monitoring result of the reporting is transmitted in a downlink message, the AI/ML model monitoring result is carried in a radio resource control (RRC) message, system information, medium access control (MAC) control element (CE), downlink control information (DCI), PDSCH, PDCCH, or LPP message.

4. The model management method of claim 2, wherein an AI/ML model monitoring result report comprises one or more of AI/ML model monitoring report configuration ID, AI/ML model ID, AI/ML model monitoring result, and triggering event of model monitoring reporting.

5. The model management method of claim 1, wherein the AI/ML model monitoring configuration comprises one or more of:
AI/ML monitoring configuration ID,
AI/ML model ID,
AI/ML model monitoring object,
AI/ML model monitoring metrics,
AI/ML model monitoring report configuration,
AI/ML model monitoring report configuration ID,
AI/ML model monitoring report type,
AI/ML model monitoring threshold,
AI/ML model monitoring reference signal,
AI/ML model monitoring time window,
time to trigger,
model monitoring reporting amount,
monitoring reporting interval,
hysteresis parameter (Hys),
activating time offset,
UE ID,
Scenario ID,
Feature ID,
Cell ID,
Site ID,
Zone ID, and
data quality indicator.

6. The model management method of claim 1, further comprising:
transmitting or receiving AI/ML model monitoring activation and deactivation signaling;
wherein the AI/ML model monitoring activation and deactivation signaling comprises one or more of: AI/ML model monitoring threshold, AI/ML model monitoring object, activating time, and deactivating time.

7. The model management method of claim 1, wherein the AI/ML model monitoring configuration is sent in a downlink message comprising a radio resource control (RRC) message, system information, medium access control (MAC) control element (CE), downlink control information (DCI), PDSCH, PDCCH, or LPP message; or
the AI/ML model monitoring configuration is sent in an uplink message comprises MAC CE, UCI, a radio resource control (RRC) message, physical uplink control channel (PUCCH), physical uplink shared channel (PUSCH), or LTE Positioning Protocol (LPP) message.

8. The model management method of claim 1, further comprising:
making a decision associated with at least one AI/ML model, wherein the decision at least comprises an actions of lifecycle management.

9. The model management method of claim 8, wherein the actions of lifecycle management comprise AI/ML model activation, deactivation, model selection, model switching, or fallback.

10. The model management method of claim 8, wherein the decision is triggered based on a threshold-based approach, a rule-based approach, a ML-based approach, or an expert-system-based approach.

11. The model management method of claim 8, wherein the decision is made by a UE or NW.

12. The model management method of claim 10, wherein in the rule-based approach comprises at least one of:
a decision rule is based on a threshold;
a decision rule is based on candidate models;
a decision rule is based on AI/ML model monitoring methods; and/or
a decision rule is predefined or preconfigured; and/or
a decision rule comprises a default rule.

13. The model management method of claim 12, wherein in the rule-based approach, threshold-based decision rules are based on different thresholds defined for different actions of lifecycle management, and/or for different AI/ML model monitoring methods.

14. The model management method of claim 1, wherein the model monitoring is triggered by an event where performance of the at least one AI/ML model becomes worse than an AI/ML model performance threshold; or
the model monitoring is triggered by an event where performance of the at least one AI/ML model becomes better than an AI/ML model performance threshold.

15. The model management method of claim 1, wherein the model monitoring is performed by a user equipment (UE) or NW.

16. The method of claim 1, wherein AI/ML model activation for one or more AI/ML models is signaled by the AI/ML model monitoring configuration or an activation message or is controlled according to a predefined rule.

17. The method of claim 16, wherein the activation message comprises AI/ML model Activate/Deactivate information for the AI/ML model activation, and the AI/ML model Activate/Deactivate information comprises one or more of:
an AI/ML model ID,
activate/deactivate information,
activate timing,
deactivate timing, and
a timing window.

18. A user equipment (UE) comprising:
a processor configured to call and run a computer program stored in a memory, to cause a device in which the processor is installed to execute operations comprising:
performing AI/ML model monitoring for one or more AI/ML models and/or lifecycle management (LCM) for the one or more AI/ML models according to AI/ML model monitoring configuration.

19. (canceled)

20. A non-transitory computer-readable storage medium, in which a computer program is stored, wherein the computer program causes a computer to execute operations comprising:
performing AI/ML model monitoring for one or more AI/ML models and/or lifecycle management (LCM) for the one or more AI/ML models according to AI/ML model monitoring configuration.

21-23. (canceled)
